(19) United States
(12) Patent Application Publication
(10) Pub. No.: US 2026/0313729 A1
(43) Pub. Date: Oct. 8, 2026

(54) RADIO BASE STATION, TERMINAL, AND RADIO COMMUNICATION SYSTEM

(71) Applicant: NTT DOCOMO, INC., Tokyo (JP)

(72) Inventors: Tianyang MIN, Tokyo (JP); Shoki INOUE, Tokyo (JP); Masato TANIGUCHI, Tokyo (JP); Souki WATANABE, Tokyo (JP); Mio NAKAMURA, Tokyo (JP)

(73) Assignee: NTT DOCOMO, INC., Tokyo (JP)

(21) Appl. No.: 18/880,623

(22) PCT Filed: Jul. 8, 2022
(86) PCT No.: PCT/JP2022/027170

§ 371 Date: Jan. 2, 2025

(51) Int. Cl. H04W 76/15; H04W 24/10

(52) U.S. Cl. CPC H04W 76/15; H04W 24/10

(57) ABSTRACT

A radio base station performs communication with a terminal through one or more radio communication devices connected to same base station device. When the terminal transits from a first cell to a second cell that are formed by the radio communication device, the radio base station establishes a state where both the first cell and the second cell are connected to the terminal by using a layer 1 function.

### TECHNICAL FIELD

The present disclosure relates to a radio base station, a terminal, and a radio communication system.

### BACKGROUND ART

The 3rd Generation Partnership Project (3GPP®) has prepared a specification for the 5th generation mobile communication system (also called 5G, New Radio (NR), or Next Generation (NG)) and is also preparing next generation specifications called Beyond 5G, 5G Evolution, or 6G.

For example, in 3GPP Release-18, expansion of mobility of terminals (User Equipment, UE) is planned (Non-Patent Literature 1). Specifically, mobility control at layer 1 and/or layer 2 (which may be called L1/L2 Mobility) has been considered for the purpose of lower delay, smaller overhead, and shorter downtime than existing mobility at layer 3.

### CITATION LIST

### Non-Patent Literature

Non-Patent Literature 1: “Revised WID on Further NR mobility enhancements”, RP-221558, 3GPP TSG RAN Meeting #96, 3GPP, June 2022

### SUMMARY OF THE INVENTION

However, when L1/L2 Mobility is realized, the following issues are considered. For example, when a radio base station (GNB) includes a central unit (CU) and a distributed unit (DU), and a UE performs a handover (transition) between multiple DUS (cells) connected to the same CU, a medium access control layer (MAC) and/or a radio link control layer (RLC) cannot be reset, and the handover may fail.

In addition, the existing handover is triggered on the basis of a measurement report in layer 3 from the UE, but in the case of L1/L2 Mobility, a handover triggered by such a measurement report cannot be performed.

Thus, the following disclosure is made in view of such situation and is intended to provide a radio base station, a terminal, and a radio communication system that are capable of realizing more reliable L1/L2 Mobility.

An aspect of the present disclosure is a radio base station (gNB 100) including a communication unit (radio communication unit 110) that performs communication with a terminal (UE 200) through one or more radio communication devices (DUs) connected to same base station device (CU), and a control unit (control unit 140) that, when the terminal transits from a first cell to a second cell that are formed by the radio communication device, establishes a state where both the first cell and the second cell are connected to the terminal by using a layer 1 function.

An aspect of the present disclosure is a terminal (UE 200) including a control unit (control unit 240) that controls a measurement of a cell including a serving cell, and a transmission unit (measurement reporting unit 220) that transmits a report of the measurement, wherein the control unit controls a measurement of the serving cell and a neighbor cell at layer 1.

An aspect of the present disclosure is a radio communication system (radio communication system 10) including a terminal, and a radio base station, wherein the terminal includes a control unit (control unit 240) that performs a measurement of a serving cell, and a transmission unit (measurement reporting unit 220) that transmits a report of the measurement, the radio base station includes a reception unit (measurement configuration unit 130) that receives the report, the control unit performs a measurement of the serving cell and a neighbor cell at layer 1, and the reception unit receives the report including a measurement results of the serving cell and the neighbor cell.

### BRIEF DESCRIPTION OF DRAWINGS

FIG. 1 is an overall schematic configuration diagram of a radio communication system 10.

FIG. 2 is a diagram illustrating an example configuration of an inter-DU inter-cell handover.

FIG. 3 is a diagram illustrating an example configuration of an intra-DU inter-cell handover.

FIG. 4 is a functional block configuration diagram of a gNB 100.

FIG. 5 is a functional block diagram of a UE 200.

FIG. 6 is a diagram illustrating an operation example from the viewpoint of a user plane when Intra-DU L1/L2 Mobility or Inter-DU L1/L2 Mobility is applied.

FIG. 7 is a diagram illustrating a configuration example (dual connectivity connection) of cells and radio link control layers when an L1/L2 Mobility procedure is executed.

FIG. 8 is a diagram illustrating a configuration example of a radio link control layer and a packet data convergence protocol layer (user plane) in dual connectivity.

FIG. 9 is a diagram illustrating a sequence example of an Inter-DU L1/L2 Mobility procedure based on dual connectivity.

FIG. 10 is a diagram illustrating a sequence example of an Intra-DU L1/L2 Mobility procedure based on carrier aggregation.

FIG. 11 is a diagram illustrating a transfer example of downlink (DL) data (packets) when the Inter-DU L1/L2 Mobility procedure is executed.

FIG. 12 is a diagram illustrating a transfer example of uplink (UL) data (packets) when the Inter-DU L1/L2 Mobility procedure is executed.

FIG. 13 is a diagram illustrating a sequence example of the Inter-DU L1/L2 Mobility procedure based on dual connectivity (for the first case, when multiple candidate cells are set in UE without DC connection in advance).

FIG. 14 is a diagram illustrating a sequence example of the Inter-DU L1/L2 Mobility procedure based on dual connectivity (for the second case, when multiple candidate cells are set in UE without DC connection in advance).

FIG. 15 is a diagram illustrating a configuration example of cells and a radio link control layers when the L1/L2 Mobility procedure is executed (when multiple candidate cells are set in UE).

FIG. 16 is a diagram illustrating a sequence example of the Intra-DU L1/L2 Mobility procedure based on carrier aggregation (for the first case, when multiple candidate cells are set in UE without CA connection in advance).

FIG. 17 is a diagram illustrating a sequence example of the Intra-DU L1/L2 Mobility procedure based on carrier aggregation (for the second case, when multiple candidate cells are set in UE without CA connection in advance).

FIG. 18 is a diagram illustrating a hardware configuration example of the gNB 100 and the UE 200.

FIG. 19 is a diagram illustrating a configuration example of a vehicle 2001.

### DESCRIPTION OF EMBODIMENTS

Embodiments will be described below with reference to the drawings. Note that the same or similar reference numerals have been attached to the same functions and configurations, and the description thereof is omitted as appropriate.

### (1) Overall Schematic Configuration of Radio Communication System

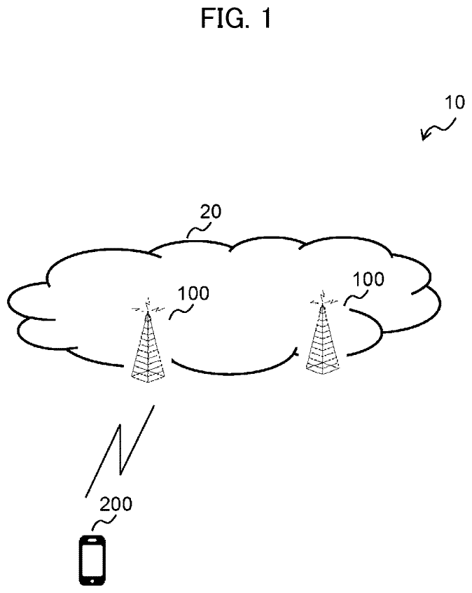

FIG. 1 is an overall schematic configuration diagram of a radio communication system 10 according to the present embodiment. The radio communication system 10 is a 5G New Radio (NR) compliant radio communication system and includes a next generation-radio access network 20 (hereinafter, NG-RAN 20) and a terminal 200 (user equipment 200, hereinafter, UE 200).

Note that the radio communication system 10 may be compliant with a radio communication system called Beyond 5G, 5G Evolution, or 6G, or may include a radio communication system compliant with a system called Long Term Evolution (LTE) or 4G. The radio communication system 10 may support functions related to Industrial Internet of Things (IIoT) and URLLC (Ultra-Reliable and Low Latency Communications).

The NG-RAN 20 includes a radio base station 100 (hereinafter, qNB 100). Note that the specific configuration of the radio communication system 10, including the number of the qNBs (may be eNBs or the like) and the UEs, is not limited to the example in FIG. 1.

The gNB 100 may also adopt a fronthaul (FH) interface specified by O-RAN (Open Radio Access Network Alliance). The qNB 100 may include an O-DU (O-RAN Distributed Unit) and an O-RU (O-RAN Radio Unit). The gNB 100 can function as a kind of NG-RAN node.

The NG-RAN 20 actually includes multiple NG-RAN Nodes, specifically gNBs (or ng-eNBs), and is connected to a 5G-compliant core network (5GC, not illustrated). In the 5GC, the concept of CUPS (Control and User Plane Separation) may be introduced where a user plane function and a control plane function are clearly separated.

An Access and Mobility Management Function (AMF) providing an access and mobility management function of a UE 200, a Session Management Function (SMF) providing a session management function, or the like, which are included in the system architecture of 5G, are connected to the NG-RAN 20. A UDM/UDR (Unified Data Management/User Data Repository) may be connected to the AMF and/or SMF. Note that the NG-RAN 20 and 5 GC may be expressed simply as a “network”.

The gNB 100 is an NR-compliant radio base station and performs radio communication with the UE 200 according to NR. Note that the qNB 100 may include a CU (Central Unit) and a DU (Distributed Unit), and the DU may be separated from the CU and installed at a different geographical location. The gNB 100 (gNB-CU) may be connected through an Xn interface.

The gNB 100 and the UE 200 can support Massive MIMO generating a beam with higher directivity by controlling radio signals transmitted from multiple antenna elements, a Carrier Aggregation (CA) bundling and using multiple Component Carriers (CCs), Dual Connectivity (DC) performing simultaneous communication between a UE and each of the multiple NG-RAN Nodes, and the like.

In addition, in the radio communication system 10, mobility control (L1/L2 Mobility) at Layer 1 and/or Layer 2 may be applied in addition to mobility control (L3 Mobility) of the UE 200 at Layer 3. L3 Mobility may be interpreted as a mobility control at a radio resource control layer (RRC). In contrast, L1/L2 Mobility may be interpreted as a mobility control at a physical layer (PHY), a media access control layer (MAC), a radio link control layer (RLC), and a packet data convergence protocol layer (PDCP).

Layer 1 may be interpreted as including a lower layer, such as a PHY. Layer 3 is a layer higher than Layer 1. The higher layer may include an RRC, and may include at least one of a MAC, an RIC, or a PDCP.

Mobility of a UE 200 may mean ease of movement and maneuverability of the UE 200 in a broad sense, but in the present embodiment, it may mean transition between cells. The transition between cells may include a handover and a cell selection (including cell reselection). Note that mobility of the UE 200 may mean minimization of a call drop, a radio link (including beam) failure, an unnecessary handover, a ping-pong condition, or the like.

L1/L2 Mobility, which is lower in layers than L3 Mobility, can achieve lower latency, lower overhead, shorter downtime, and the like, than L3 Mobility.

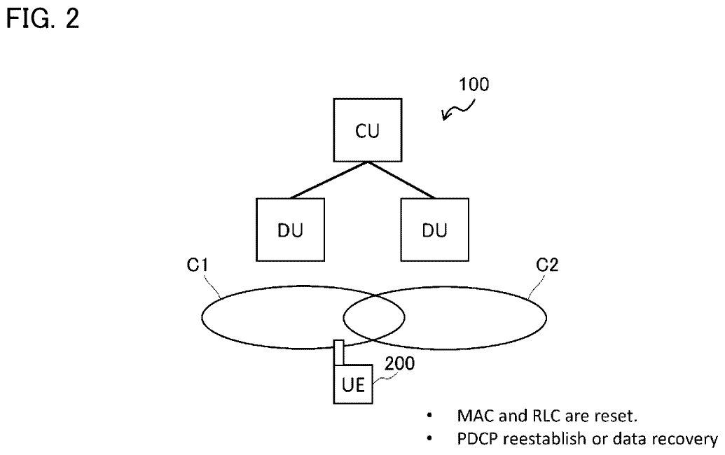

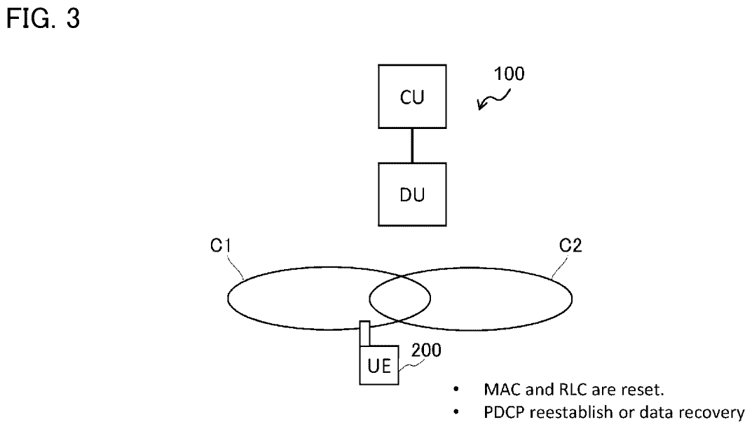

FIG. 2 illustrates an example configuration of an Inter-DU inter-cell handover. FIG. 3 illustrates an example configuration of an Intra-DU inter-cell handover.

As described above, the gNB 100 can adopt a CU-DU configuration. As illustrated in FIG. 2, multiple DUs may be connected to one CU, or as illustrated in FIG. 3, one DU may be connected to one CU. The DU may form one or more cells, specifically cells C1 and C2.

For example, as illustrated in FIG. 2, one DU may form cell C1, and the other DU may form cell C2. Alternatively, as illustrated in FIG. 3, one DU may form cells C1 and C2.

An inter-cell handover as illustrated in FIG. 2 may be called an Inter-DU inter-cell handover. An inter-cell handover as illustrated in FIG. 3 may be called an Intra-DU inter-cell handover.

In the case of L3 Mobility, when such a handover is performed, the MAC and RLC may be reset, and PDCP reset or data recovery may be performed. In the case of L1/L2 Mobility, the MAC and/or RLC may not necessarily be reset (some may be reset).

### (2) Functional Block Configuration of the Radio Communication system

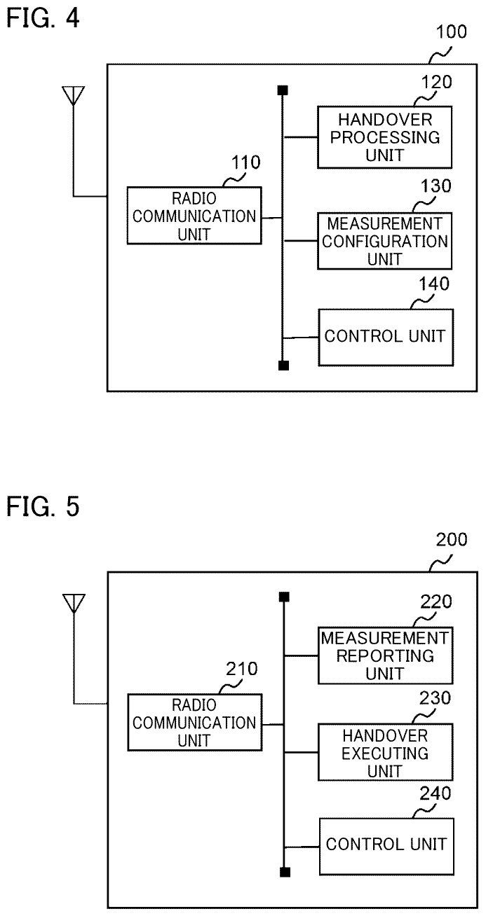

Next, a functional block configuration of the radio communication system 10 will be described. Specifically, a functional block configuration of the gNB 100 and the UE 200 will be described. FIG. 4 is a functional block configuration diagram of the qNB 100. FIG. 5 is a functional block configuration diagram of the UE 200.

### (2.1) gNB 100

As illustrated in FIG. 4, the gNB 100 includes a radio communication unit 110, a handover processing unit 120, a measurement configuration unit 130, and a control unit 140.

The radio communication unit 110 transmits a downlink signal (DL signal) compliant with NR. Further, the radio communication unit 110 receives an uplink signal (UL signal) compliant with ITE.

In the present embodiment, the radio communication unit 110 may include a communication unit that performs communication with a terminal via a radio communication device connected to the same base station device. Specifically, the radio communication unit 110 can perform communication with the UE 200 via a DU connected to the same CU.

Note that the CU may be called a central device, an aggregation device, or the like, and the DU may be called a distribution device, an extension device, or the like.

The handover processing unit 120 executes a handover of the UE 200. Specifically, the handover processing unit 120 executes a handover from a serving cell of the UE 200 to the neighboring other cell.

Note that the serving cell may be interpreted simply as a cell to which the UE 200 is connected. More specifically, in the case of an RRC CONNECTED UE without a carrier aggregation (CA), only one serving cell forms a primary cell. In the case of an RRC CONNECTED UE configured with a CA, the serving cell may be interpreted as representing a set of one or more cells including a primary cell and all secondary cells.

The handover may also include a Conditional Handover (CHO). The CHO can execute a UE 200 initiated handover when a specific execution condition is satisfied. If the CHO is not applicable, a normal handover may be performed (also called CHO recovery). In CHO recovery, the UE 200 performs a cell selection after CHO failure, but if a CHO candidate cell is selected, conditional RRCRReconfiguration of that cell can be directly applied and reconnected without sending an RRCRRestablementRequest to a candidate target cell.

The execution condition may include 1 or 2 trigger conditions (CHO events A3/A5 specified in 3GPP TS 38.331). Up to 2 different trigger quantities (for example, Reference Signal Received Power (RSRP) and Reference Signal Received Quality (RSRQ), RSRP and a Signal-to-Interference plus Noise power Ratio (SINR), or the like) may be set simultaneously for triggering a single reference signal (RS) type and evaluating the CHO execution condition of a single candidate cell.

The measurement configuration unit 130 executes configuration (measurement configuration) of quality measurement of a serving cell and a neighboring cell by the UE 200. Specifically, the measurement configuration unit 130 may execute the measurement configuration in Layer 3, or the measurement configuration in Layer 1 and/or Layer 2.

The measurement configuration unit 130 can notify the UE 200 of the content of the measurement configuration. The UE 200 may measure the quality of a serving cell and/or a neighboring cell based on the notified measurement configuration. The measurement configuration unit 130 can receive a measurement report indicating the measurement result of the cell quality from the UE 200. In the present embodiment, the measurement configuration unit 130 constitutes a reception unit that receives the measurement report.

The control unit 140 controls each functional block constituting the gNB 100. In particular, in the present embodiment, the control unit 140 can execute mobility control of the UE 200.

Specifically, the control unit 140 may execute control related to L3 Mobility, and/or a control related to L1/L2 Mobility. For example, with regard to L1/L2 Mobility, when the UE 200 transits from a first cell (for example, cell C1) to a second cell (for example, cell C2), which are formed by DUs (radio communication devices), the control unit 140 may establish a state where both the first cell and second cell, and the terminal are connected using the function of Layer 1 (and/or Layer 2).

Here, the state where both the first cell and second cell and the terminal are connected may mean a dual connectivity (DC) or a carrier aggregation (CA).

More specifically, in the case of an Intra-CU inter-DU HO, the control unit 140 may execute L1/L2 Mobility based on a DC. In the case of an Intra-CU intra-DU HO, the control unit 140 may execute L1/L2 Mobility based on a CA. The control unit 140 may determine a handover (HO) after receiving the measurement report of Layer 1 from the UE 200.

The type of DC may be a Multi-RAT Dual Connectivity (MR-DC) that utilizes multiple radio access technologies, or an NR-NR Dual Connectivity (NR-DC) that utilizes only NR. The MR-DC may be an E-UTRA-NR Dual Connectivity (EN-DC) where an eNB constitutes a master node (MN), and a gNB constitutes a secondary node (SN), or vice versa, an NR-E-UTRA Dual Connectivity (NE-DC).

In the DC, a master cell group (MCG) and a secondary cell group (SCG) may be configured. The MCG may include a primary cell (PCell), and the SCG may include a secondary cell (SCell).

The control unit 140 may activate the SCG, switch between the PCell and the PSCell, release the SCG after completion of an HO, or cause the SCG to be deactivated. In addition, the control unit 140 may activate PDCP duplication to operate two PDCPs simultaneously during an HO.

In addition, the SCell may include a primary secondary cell (PSCell). The PSCell is a type of SCell, but may be interpreted as a special SCell having the same functions as the PCell. Like the PCell, the PSCell may perform the following functions: transmission of a PUCCH (Physical Uplink Control Channel), contention-based random access procedure (CBRA), Radio Link Monitoring (downlink radio quality monitoring), and the like.

RA procedure may be simply read as a random access channel (RACH). The RA procedure (RACH) may include two-step RACH and four-step RACH.

The RA procedure (RACH) may include two-step RACH and four-step RACH. In the two-step RACH, messages (MSG) A, B (Random Access Preamble, Contention Resolution/Random Access Response) may be transmitted and received. In the four-step RACH, MSGs 1 to 4 (Random Access Preamble, Random Access Response, Scheduled Transmission, Contention Resolution) may be transmitted and received.

Note that in the present embodiment, a channel includes a control channel and a data channel. The control channel includes PDCCH (Physical Downlink Control Channel), PUCCH (Physical Uplink Control Channel), PRACH (Physical Random Access Channel), PBCH (Physical Broadcast Channel), and the like.

The data channel includes a PDSCH (Physical Downlink Shared Channel), a PUSCH (Physical Uplink Shared Channel), and the like

Note that the reference signal includes a Demonstration Reference Signal (DMRS), a Sounding Reference Signal (SRS), a Phase Tracking Reference Signal (PTRS), a Channel State Information-Reference Signal (CSI-RS), and the like, and the signal includes a channel and a reference signal. The data may mean data transmitted through the data channel.

Further, the control unit 140 may cause unacknowledged data (un-Acked data) in the RLC (first radio link control layer) of the first cell side of the DU to be transmitted to the PDCP of the CU (base station device) side, and the PDCP of the CU may cause the data to be transmitted to the RLC (second radio link control layer) of the second cell side of the DU. The un-Acked data may be interpreted as data for which the gNB 100 has not received an Acknowledgement. The data may be replaced by a packet or a protocol data unit (PDU).

Furthermore, the RLC (first radio link control layer) of the first cell side of the DU may reset the first radio link control layer and then retransmit the data to the RIC (second radio link control layer) of the second cell side of the DU. Alternatively, the data may be retransmitted to the second radio link control layer without resetting the first radio link control layer, and after retransmitting the data, the first radio link control layer may be reset. Note that there may be a time when both the RLC of the first cell side of the DU and the RLC of the second cell side of the DU are transiently configured.

### (2.2) UE 200

As illustrated in FIG. 5, the UE 200 includes a radio communication unit 210, a measurement reporting unit 220, a handover executing unit 230, and a control unit 240.

The radio communication unit 210 transmits an uplink signal (UL signal) compliant with NR. The radio communication unit 210 also receives an uplink signal (DL signal) compliant with NR.

The measurement reporting unit 220 can measure the quality of a serving cell of a UE 200 and a neighbor cell of the serving cell, and report the measurement result (measurement report) to the network. The measurement reporting unit 220 may execute measurement reporting of a source cell and a target cell at a handover. In the present embodiment, the measurement reporting unit 220 constitutes a transmission unit that transmits the measurement report.

The quality of a measurement object may be, for example, the quality included in the Measurement Report specified in the 3GPP TS38.331 (for example, Reference Signal Received Power (RSRP), Reference Signal Received Quality (RSRQ), and the like).

The measurement reporting unit 220 may execute measurement in layer 1 (and/or layer 2) of a serving cell and a neighbor cell in addition to measurement in layer 3. The measurement in layer 1 and/or layer 2 may be interpreted as measurement using a layer function on at least one of a PHY, a MAC, a RLC, or a PDCP, and as a report of the measurement result, as well as in L1/L2 Mobility.

The handover executing unit 230 executes a handover of the UE 200. Specifically, the handover executing unit 230 may execute a handover to a transition destination cell (NG-RAN node) on the basis of the control by the qNB 100.

Also, the handover executing unit 230 can execute processes related to a normal handover (legacy handover) and a conditional handover (CHO).

In the case of a CHO, the handover executing unit 230 may transit to a candidate cell when an execution condition is satisfied. As described above, the execution condition may be determined on the basis of the quality of a reference signal (RS), specifically, the value of RSRP, RSRQ, or a SINR.

The transition destination of the CHO need not be accompanied by an SCG, or may be accompanied by an SCG. In other words, the transition destination cell of the CHO may be a single cell, or may include multiple cells (which may be read as a cell group) compliant with DC.

The control unit 240 controls each functional block constituting the UE 200. Specifically, the control unit 240 can execute registration of the UE 200 to the network (waiting for a specific cell), measurement reporting, and control of a handover of the UE 200.

The control unit 240 controls measurement of cells including a serving cell. Specifically, the control unit 240 can control the measurement of a serving cell and a neighbor cell in layer 1 (and/or layer 2). That is, the control unit 240 can execute the measurement of a serving cell and a neighbor cell (which may be called L1 measurement) using the function of layer 1 (and/or layer 2).

When a failure occurs in layer 1 (and/or layer 2), the control unit 240 may notify its own station RRC of the failure information. Note that the failure information may be notified to a layer other than the RRC (e.g. MAC, RLC, or PDCP). The failure information is not particularly limited, but may include identification information (ID) of a source cell (handover source), identification information (ID) of a target cell (handover destination), and/or the quality of the cell (or may be of a beam).

### (3) Operation of Radio Communication System

Next, the operation of the radio communication system 10 will be described. Specifically, operation related to mobility control (L1/L2 Mobility) in Layer 1 and/or Layer 2 will be described.

### (3.1) Operation Example 1

### (3.1.1) Issue

In the intra-CU inter-cell handover (intra-DU inter-cell handover (HO) or inter-DU inter-cell handover (HO)) compliant with conventional L3 Mobility, the MAC and RLC are reset, and PDCP re-establishment or PDCP data recovery is executed for the PDCP. PDCP data recovery may be interpreted as a sending PDCP side executes retransmission of a PDCP data PDU that was previously sent to a re-established or released AM (Acknowledged Mode) RLC entity and has not been acknowledged to be normally delivered by a lower layer, in ascending order of an associated COUNT value.

In the case of L1/L2 Mobility, in the intra-DU/inter-DU inter-cell HO, the MAC and RLC are not reset, or a portion of them are reset, and a normal handover may not be possible. In particular, when a part of the layer is to be reset, the question is which part is subject to be reset.

### (3.1.2) Solution

The following is an example solution from the viewpoint of a user plane (U-plane) perspective to solve the above issue.

### (3.1.2.1) Intra-DU L1/L2 Mobility or Inter-DU L1/L2 Mobility

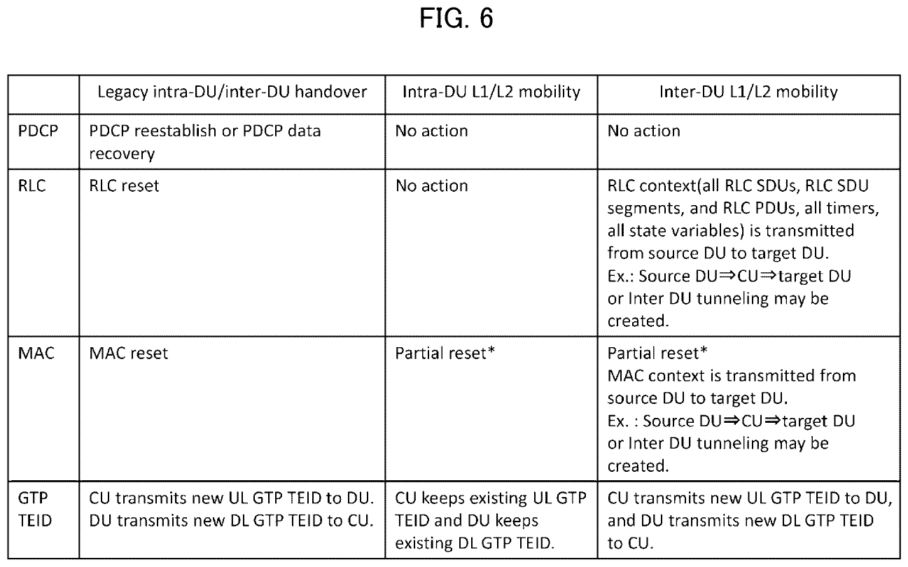

FIG. 6 illustrates an example operation from the viewpoint of a user plane when Intra-DU L1/L2 Mobility or Inter-DU L1/L2 Mobility is applied.

As illustrated in FIG. 6, in Intra-DU L1/L2 Mobility or Inter-DU L1/L2 Mobility, some functions (procedures) of the MAC may be reset. In addition to the MAC, some functions (procedures) of the RLC may be reset.

When some functions (procedures) of the MAC are reset, for example, among the following functions (procedures) of the MAC, functions (procedures) other than those enclosed in [ ] may be reset.
[initialize Bj for each logical channel to zero;]
stop (if running) all timers;
consider all timeAlignmentTimers as expired and perform the corresponding actions in clause 5.2;
[set the NDIs for all uplink HARQ processes to the value 0]
stop, if any, ongoing RACH procedure;
discard explicitly signaled contention-free Random Access Resources, if any
[flush Msg3 buffer;]
cancel, if any, triggered Scheduling Request procedure;
cancel, if any, triggered Buffer Status Reporting procedure;
cancel, if any, triggered Power Headroom Reporting procedure;
[flush the soft buffers for all DL HARQ processes;]
[for each DL HARQ process, consider the next received transmission for a TB as the very first transmission;]
release, if any, Temporary C-RNTI;
reset BFI_COUNTER.

Functions (procedures) enclosed in brackets [ ] may be interpreted as functions (procedures) of a U-plane system, and functions (procedures) not enclosed in brackets [ ] may be interpreted as functions (procedures) of a control plane (C-plane) system. In other words, functions (procedures) of the C-plane system may be reset.

### (3.1.2.2) Intra-CU inter-DU HO or Intra-CU intra-DU HO

In the case of the Intra-CU inter-DU HO (see FIG. 2), DC based L1/L2 Mobility may be executed. In the case of the Intra-CU intra-DU HO (see FIG. 3), CA based L1/L2 Mobility may be executed.

Specifically, a DC state may be established between a source DU and a candidate target DU. The candidate target DU may be interpreted as a DU (cell) that can be a candidate for a handover destination.

In the case of the Intra-DU HO, the candidate target cell may be added as an SCell in the DU. Alternatively, the configuration of the candidate target cell may be configured in advance in the UE without establishing a DC state. The configuration may be indicated to the UE by a message of the MAC, RRC, or the like, or may be configured in advance in the UE.

In addition, the SCG and/or the SCcell may be set to a deactivated state for power saving and effective resource utilization. The deactivated state may be interpreted as a state where the configurations of the cell (or cell group) are released, or a state where all configurations are not released and some configurations are maintained.

The SCG may be set to a DRX (Discontinuous Reception) state, or may not be set to the deactivated or the DRX state.

The source DU may decide the HO after receiving the quality measurement result (L1 measurement report) from the UE. Specifically, L1/L2 Mobility (HO) may be executed by any of the following:
After the UE receives an L1L2 mobility command from
When the UE does not receive an HO instruction from the gNB but satisfies a predetermined execution condition (event X), the execution of the L1/L2 Mobility (HO) may occur simultaneously with the reception of the L1L2 mobility command or the satisfaction of event X, or within a predetermined time after the reception of the L1L2 mobility command or the satisfaction of event X.

The predetermined execution condition (event X) may be any of the following, for example.
The quality of the target cell is better than that of the source cell by an offset.
The quality of the target cell is better than a predetermined threshold.
The quality of the source cell is worse than a predetermined threshold, and the quality of the target cell is better than the predetermined threshold.

In the case of DC based L1/L2 Mobility, the SCG may be activated, and the PCell and the PSCell may be switched, during the HO. In the case of CA based L1/L2 Mobility, the cell may be activated, and the PCell and the SCell may be switched, or the PSCell and the SCell may be switched, during the HO.

In this case, the PDCP duplication may be activated during the HO. In addition, the RLC of the source DU may transfer un-Acked data to the PDCP of the CU side, and the PDCP of the CU side may transfer the data to the RLC of the target DU. Specifically, the source RLC may resend the un-Acked data after being reset, or the source RLC may not be reset immediately, but transfer the un-Acked data to the target RLC and then be reset.

Here, the RLC of the source DU and the RLC of the target DU may transiently be in a state of duplication (both active). The RLC of the source DU may be reset after receiving a transmission completion instruction from the CU to the target RLC.

In addition, the CU may refer to the highest delivered sequence number/highest transmitted sequence number through DDDS (Downlink Data Delivery Status) feedback from the source DU to determine which PDUs have not been successfully delivered to the UE. The CU may resend the PDUs that have not been successfully delivered by the source DU, to the target DU. After HO completion, the SCG may be released or deactivated.

After L1/L2 Mobility completion, the UE may retain the configuration of the candidate target cell without resetting, or the configuration of the source cell without resetting. This has an advantage in that if the quality of a target cell is poor immediately after a handover to the target cell, a handover to the source cell or another candidate target cell can be immediately performed. After receiving an instruction to release the configuration of the candidate target cell or source cell via Layer 1 and/or Layer 2 signaling or an RRC message, from the network, the UE may release the configuration.

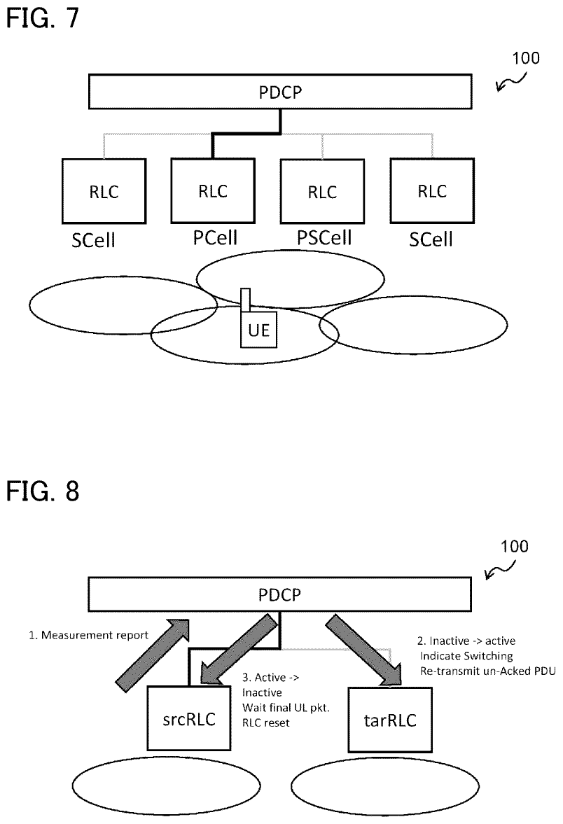

FIG. 7 illustrates a configuration example (dual-connectivity connection) of a cell and a radio link control layer when the L1/L2 Mobility procedure is executed. As illustrated in FIG. 7, RLCs for each cell are set in the qNB 100, and among them, an RLC for PCell may be activated. The UE may execute an HO to PSCell or SCell. The PCell and PSCell, and the PSCell and SCell may be switched as described above.

FIG. 8 illustrates a configuration example of the radio link control layer and the packet data convergence protocol layer (user plane) during dual connectivity. As illustrated in FIG. 8, the PDCP of the gNB 100 may receive a measurement report from the UE via the source RLC. The PDCP may retransmit un-Acked data via the target RLC.

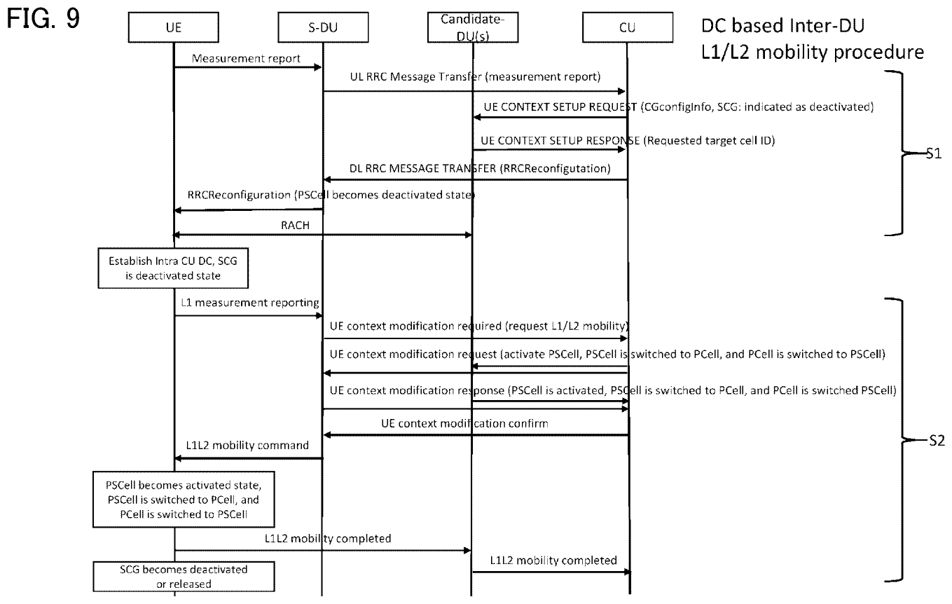

FIG. 9 illustrates a sequence example of the Inter-DU L1/L2 Mobility procedure based on dual connectivity. As illustrated in FIG. 9, the CU establishes the Intra-CU DC and the PSCell is put into a deactivated state, in response to the measurement report from the UE (S1).

The UE transmits an L1 measurement report, and the gNB 100 (CU and DU) switches the PSCell to the PCell, switches the PCell to the PSCell, and completes the L1/L2 Mobility (S2). Note that when the PSCell is switched to the PCell, and the PCell is switched to the PSCell, a MAC entity may be partially reset, or may not be reset.

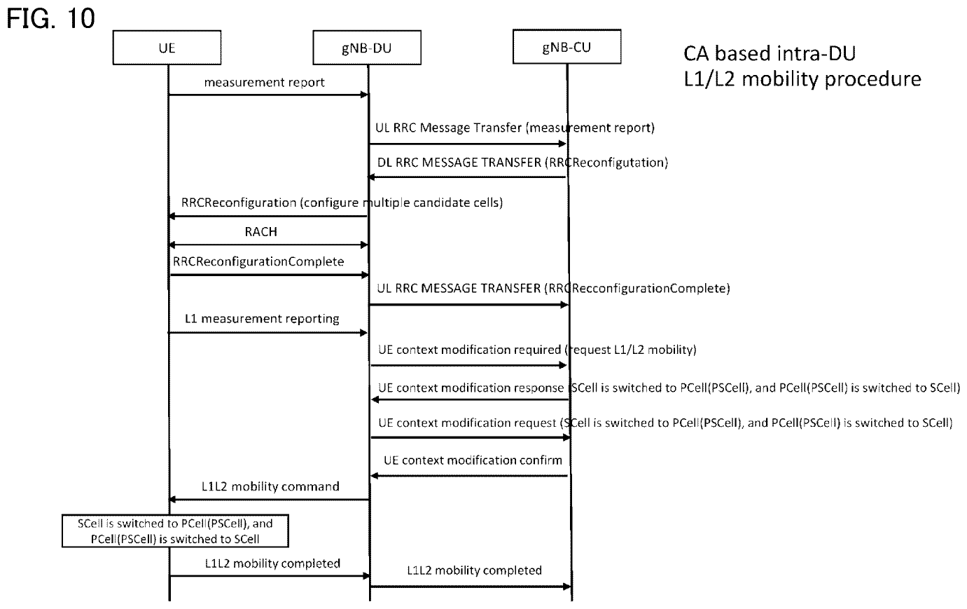

FIG. 10 illustrates a sequence example of the Intra-DU L1/L2 Mobility procedure based on a carrier aggregation. As illustrated in FIG. 10, in the case of CA based Intra-DU L1/L2 Mobility, the SCell may be switched to the PCell (PSCell), and the PCell (PSCell) may be switched to the SCell. Note that when the SCell is switched to the PCell (PSCell), and the PCell (PSCell) is switched to the SCell, a MAC entity may be partially reset or may not be reset.

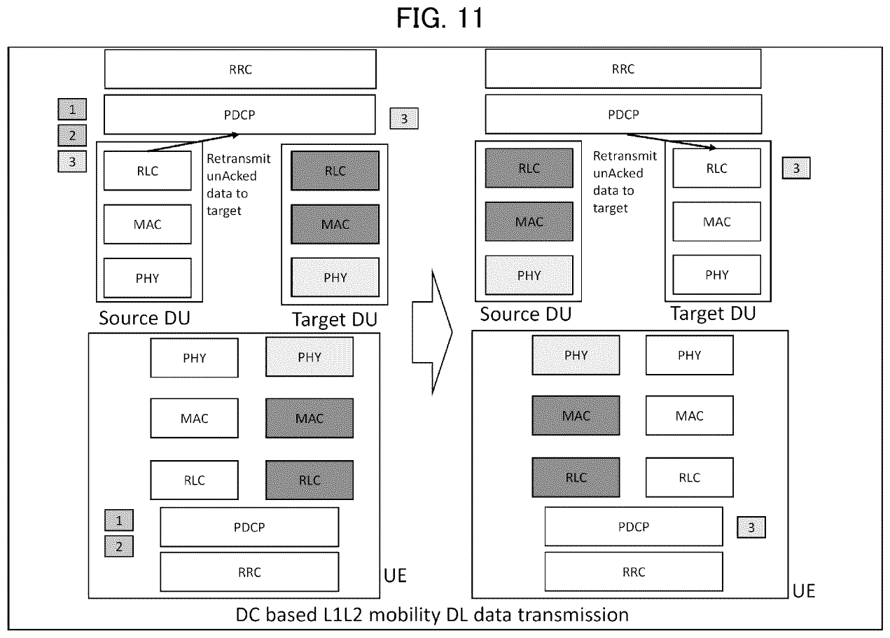

FIG. 11 illustrates a transfer example of downlink (DL) data (packets) when the Inter-DU L1/L2 Mobility procedure is executed. The example in FIG. 11 illustrates a state where a packet “3” (which may be a PDU) has not been delivered to the UE. The PDCP of the gNB 100 (CU) may transfer the packet 3 to the target RLC. The packet 3 is transmitted to the UE via the target DU. Alternatively, PDCP data recovery may be executed in the PDCP of the gNB to recover the packet 3, which is un-Acked, and transfer it to the target RLC.

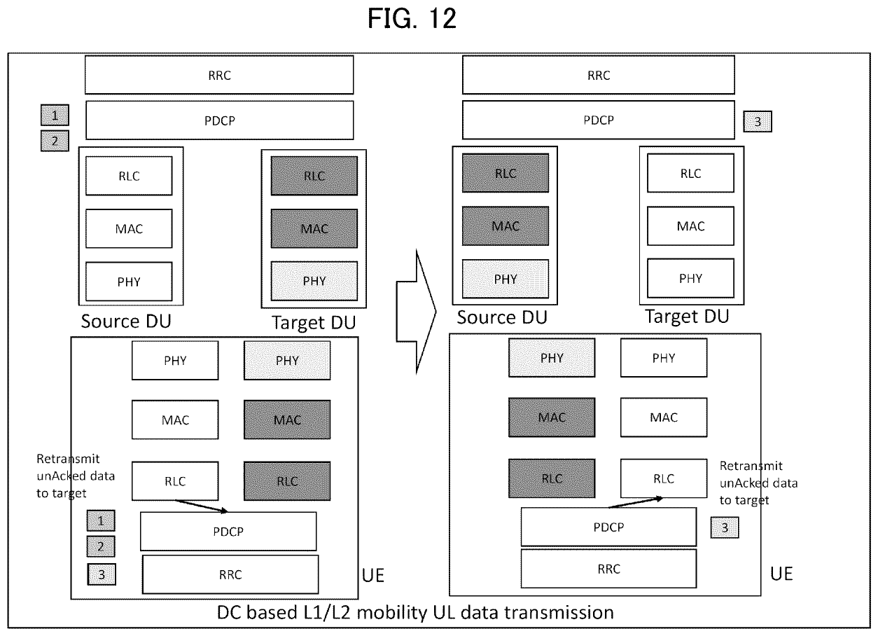

FIG. 12 illustrates a transfer example of uplink (UL) data (packets) when the Inter-DU L1/L2 Mobility procedure is executed. As in FIG. 11, the example in FIG. 12 illustrates a state where the packet 3 (which may be a PDU) has not been delivered to the qNB 100. The PDCP of the UE 200 may transfer the packet 3 to the RLC for the target DU. The packet 3 is transmitted to the qNB 100 via the RLC for the target DU. Alternatively, PDCP data recovery may be executed in the PDCP of the UE to recover the packet 3, which is un-Acked, and transfer the packet 3 to the RLC for the target DU.

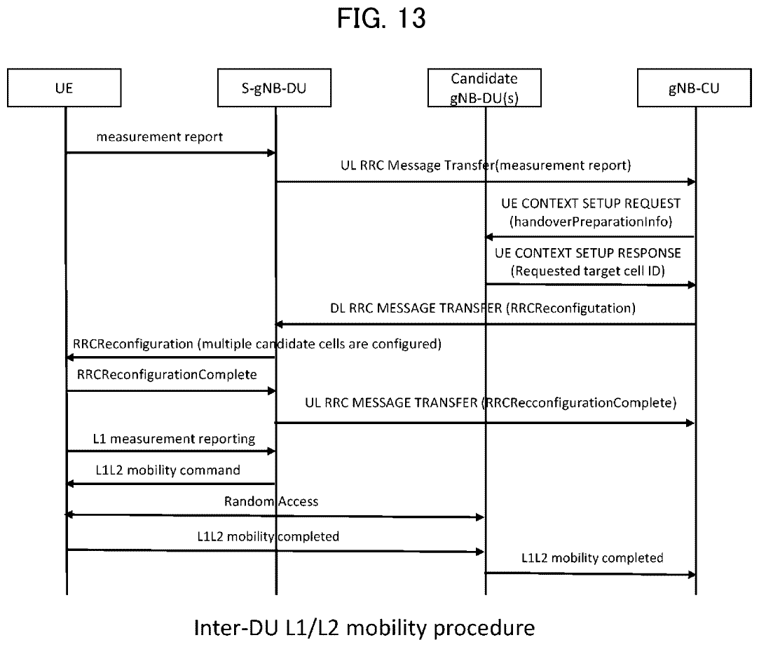

FIG. 13 illustrates a sequence example (for the first case, when multiple candidate cells are set in UE without DC connection in advance) of the Inter-DU L1/L2 Mobility procedure based on dual connectivity. Specifically, as illustrated in FIG. 13, multiple candidate cells (multiple candidate cells config) are set in the UE without DC connection in advance. This operation is similar to the CHO, and may be interpreted as the CHO.

Note that the L1L2 mobility completed command indicating the completion of L1/L2 Mobility may be a Layer 1 or Layer 2 message. For example, a PUCCH or a MAC CE (Control Element) may be used. Alternatively, the Ack of an HARQ (hybrid automatic repeat request) may be used.

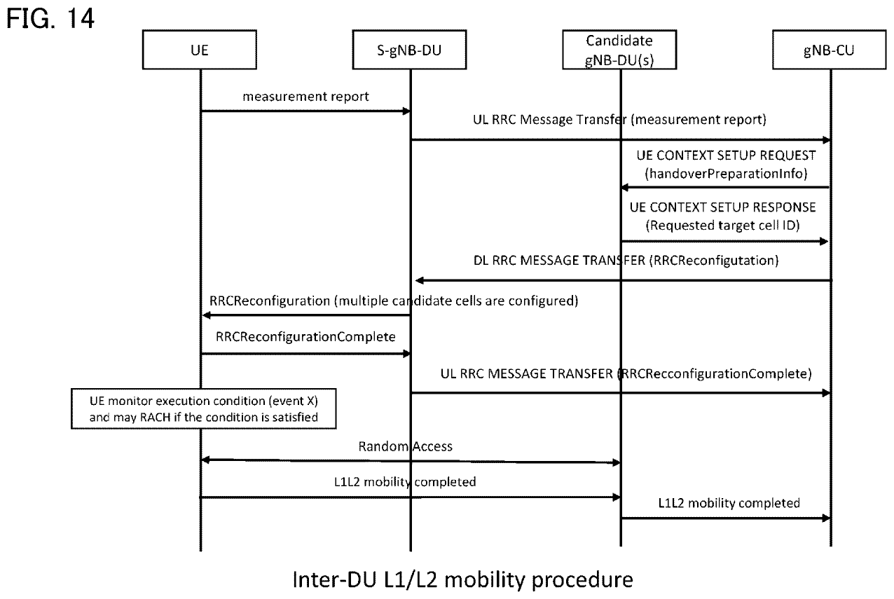

FIG. 14 illustrates a sequence example (for the second case, when multiple candidate cells are set in UE without DC connection in advance) of the Inter-DU L1/L2 Mobility procedure based on dual connectivity. As illustrated in FIG. 14, the UE may monitor the execution condition (event X) and, if the condition is satisfied, transmit an RACH, that is, execute the RA procedure. In this case, as in FIG. 13, the L1L2 mobility completed command may be a BUCCH or MAC CE.

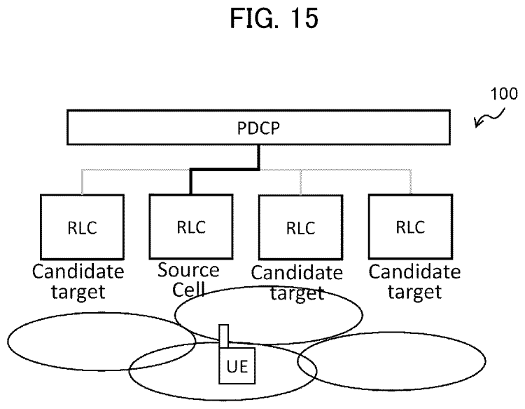

FIG. 15 illustrates a configuration example of a cell and a radio link control layer (when multiple candidate cells are set in the UE) when the L1/L2 Mobility procedure is executed. As illustrated in FIG. 15, RLCs for the source cell and multiple candidate cells are set in the gNB 100, and among them, a RLC for the source cell may be activated.

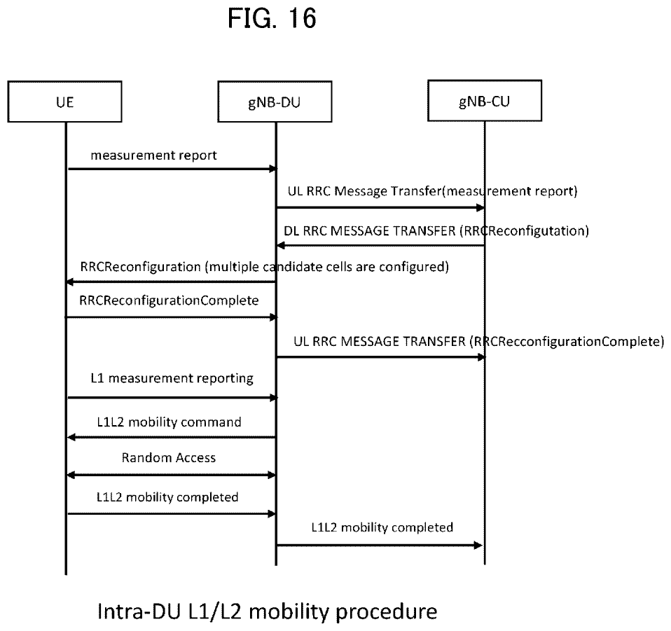

FIG. 16 illustrates a sequence example (for the first case, when multiple candidate cells are set in UE without CA connection in advance) of the Intra-DU L1/L2 Mobility procedure based on a carrier aggregation. As illustrated in FIG. 16, multiple candidate cells (multiple candidate cells config) are set in the UE without DC connection in advance.

Note that as in FIG. 13, the L1L2 mobility completed command indicating the completion of L1/L2 Mobility may be a Layer 1 or Layer 2 message. For example, a PUCCH or MAC CE (Control Element) may be used. Alternatively, the Ack of an HARQ (hybrid automatic repeat request) may be used.

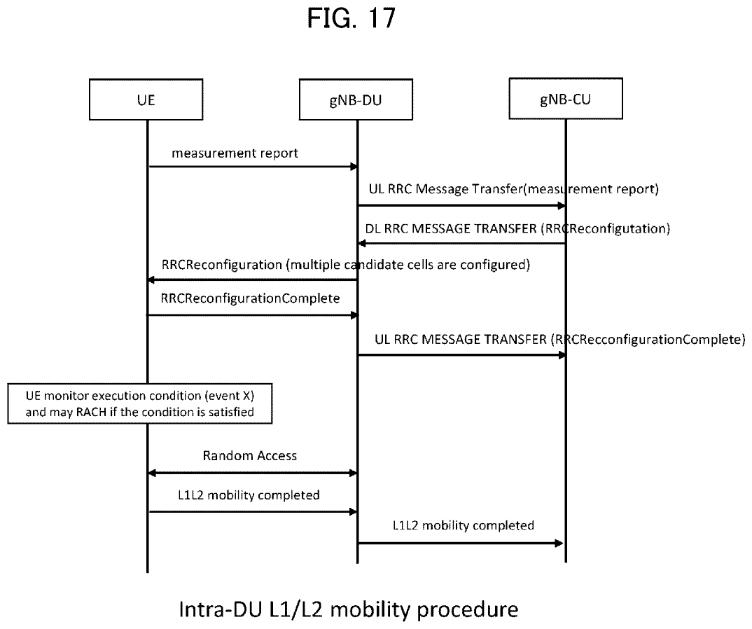

FIG. 17 illustrates a sequence example (for the second case, when multiple candidate cells are set in UE without CA connection in advance) of Intra-DU L1/L2 Mobility procedure based on a carrier aggregation.

As illustrated in FIG. 17, the UE may monitor the execution condition (event X) and, if the condition is satisfied, transmit an RACH, that is, execute the RA procedure. In this case, as in FIG. 16, the L1L2 mobility completed command may be a PUCCH or MAC CE.

According to the operation example 1 described above, by applying the measurement at Layer 1 and the message at Layer 1 and/or Layer 2, it is possible to more reliably realize mobility control of the UE at Layer 1 and/or Layer 2 while adopting the CU-DU configuration. As a result, it is possible to achieve a lower delay, a smaller overhead, and a shorter outage time for UE mobility control, especially in the U-plane.

### (3.2) Operation Example 2

In the operation example 1, operation from the viewpoint of the U-plane was mainly described. In the following, operation from the viewpoint of a C-plane is mainly described.

### (3.2.1) Issues

Regarding the C-plane of L1/L2 Mobility, the following issues should be considered.
How to specify the frequency for L1 measurement
Necessity of averaging when reporting L1 measurement
Necessity of an event that triggers L1/L2 Mobility Timer settings for managing L1/L2 Mobility
Notification to RRC in case of failure
Necessity of reconnection in case of failure, or necessity of failure recognition in RRC
Necessity of reconnection in case of failure of DC based L1/L2 Mobility
Necessity of CU-DU signaling in case of RACH-less L1/L2 Mobility

### (3.2.2) Solution

Conventional L1 measurement basically supports only serving cell (may include PCell, PSCell and SCell) measurement. Cell identification information (Cell ID) when measurement is reported is specified by servCellIndex, which is a parameter of RRC.

In order to support L1/L2 Mobility, specifically L1L2 inter-cell mobility, L1 measurement may be capable of measuring neighbor cells as well as the serving cells.

In this case, measObject, which is a parameter indicating the measurement target, may specify the frequency of L1 measurement. Alternatively, a new information element (IE) specifying the frequency of L1 measurement may be set. Cell identification information (Cell ID) may be specified by PCI (Physical Cell ID) at the time of measurement reporting.

Note that instead of the frequency, a resource block, a resource block group, a sub-carrier, a BWP (Bandwidth part), a sub-channel, or the like may be specified.

In the case of L1 RSRP, a ping-pong state (repetition of HO) may occur due to high fluctuation of values. Thus, to prevent such a state, the UE may report L1 RSRP after averaging the measured RSRP values.

In addition, a new event such as the following may be specified for L1/L2 Mobility, for example. The MAC entity may manage the event.
Event X: Neighbour becomes amount of offset better than Pcell/PScell (expression by formula: Mn>Mp+Off)

Note that the event X may be any of the following, for example.
The quality of the target cell is better than that of the source cell by an offset
The quality of the target cell is better than a predetermined threshold
The quality of the source cell is worse than the predetermined threshold, and the quality of the target cell is better than the predetermined threshold.

Note that “Neighbour” may be called a target cell or a Candidate target cell. The PCell/PSCell may be called a source cell.

Alternatively, a new timer may be specified for L1/L2 Mobility. Such a timer may be similar to an existing timer T304. Timer T304 may be started upon reception of an RRCReconfiguration message including reconfigurationWithSync, or upon execution of a conditional reconfiguration, that is, upon application of a stored RRCReconfiguration message including reconfigurationWithSync, and may be stopped upon successful completion of random access on the corresponding SpCell.

The MAC entity may manage the timer. The CU may start the timer upon reception of an L1L2 mobility command from the source DU and stop upon successful random access (RACH) with the target DU. When the timer expires, L1/L2 Mobility may be determined as failed.

The failure information of L1/L2 Mobility may be notified to the RRC. Specifically, any of the PHY, MAC, RLC, or PDCP may notify the RRC of the failure information. The failure information may include identification information (ID) of the source cell (handover source), identification information (ID) of the target cell (handover destination), and/or the quality (for example, SIR) of the cell.

In addition, if an L1/L2 Mobility failure occurs, the RRC reestablishment procedure may be triggered directly. Specifically, in the event of a DC based L1/L2 Mobility failure, reconnection may be performed using the PCI and C-RNTI (Cell Radio Network Temporary Identifier) of the source cell (PCell). Alternatively, reconnection may be performed using the PCI and C-RNTI of the target cell (PSCell).

If an L1/L2 Mobility failure occurs, the UE selects a cell, and if the UE has the configuration of the selected cell, the UE may apply the configuration of the cell directly without transmitting an RRC reestablishment request to the network.

Alternatively, if an L1/L2 Mobility failure occurs, the UE may fall back to the conventional L3 Mobility procedure.

In DC based L1/L2 Mobility, if a failure occurs in the target cell (MCG), and the source cell (SCG) is in the deactivated state, the UE may execute an RACH in the source cell (SCG) to activate the SCG. Thus, RRC reestablishment can be avoided.

Alternatively, the CU may acquire the timing difference between the target cell and the source cell, and a TA (Timing Advance) value of the target cell, from the DU, and connect the UE to the target cell without executing RACH (RACH-less) with the UE. The timing difference of the target cell and the source cell, and the TA value may be transmitted from the target DU to the CU, but if possible, they may be transmitted from the source DU to the CU. The CU may also transmit the timing difference and TA value to the source DU.

According to the operation example 2 described above, by clarifying the measurement and the operation in the event of a failure, regarding L1/L2 Mobility in the C-plane, the UE mobility control in Layer 1 and/or Layer 2 can be more reliably realized while adopting the CU-DU configuration. Thus, the UE mobility control can achieve a lower delay, a smaller overhead, and a shorter downtime.

Note that although the name L1/L2 Mobility was used in the operation example described above, L1/L2 Mobility may be a tentative name and may be called by another similar name (for example, lower layer mobility). In addition, the RLC reset may be interpreted as a synonym for stop, restart, initialization, or the like.

### (4) Actions and Effects

According to the embodiment described above, the detailed operation of the UE and network of the U-plane and C-plane when L1/L2 Mobility is applied becomes clear, and the L1/L2 Mobility can be more reliably realized.

### (5) Other Embodiments

Although the embodiments have been described above, it will be apparent to those skilled in the art that the present invention is not limited to the description of the embodiments, and that various modifications and improvements are possible.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, VE-common, and UE-shared may be read interchangeably.

The block diagram (FIGS. 4 and 5) used in the description of the above-described embodiment illustrates blocks in units of functions. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

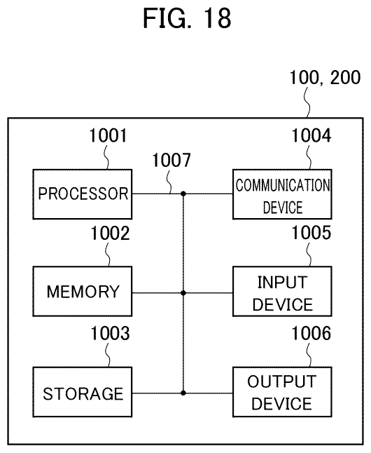

Further, the above-described gNB 100 and UE 200 (the device) may function as a computer that performs processing of a radio communication method of the present disclosure. FIG. 18 is a diagram illustrating an example of a hardware configuration of the device. As illustrated in FIG. 18, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the devices (FIGS. 4 and 5) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (DIE), DIE-Advanced (ITE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or DIE-A and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station 10. However, a combination of multiple other network nodes may be considered (e.g., MME and S-GW).

Information or signals (information and the like) may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any of a one of various different technologies. For example, data, an instruction, a command, information, a signal, a bit, a symbol, a chip, or the like, described throughout the present application, may be represented by a voltage, an electric current, electromagnetic waves, magnetic fields, magnetic particle, optical fields, a photon, or a combination thereof.

It should be noted that a term used in the present specification and/or term required for understanding of the present specification may be replaced by a term having the same or similar meaning. For example, a channel and a symbol may be a signal (signaling). Further a signal may also be a message. Further, the component carrier (CC) may be referred to as a carrier frequency, cell, frequency carrier, or the like.

As used in the present disclosure, the terms “system” and “network” are used interchangeably.

Furthermore, the information, parameters, and the like, described in the present disclosure may be expressed using absolute values, relative values from a predetermined values, or they may be expressed using corresponding different information, For example, a radio resource may be what is indicated by an index.

The names used for the parameters described above are not used as limitation. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNE (eNodeB),” a “gNB (gNodeB),” an “access point,” a “transmission point (TP),” a “reception point (RP),”a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs)) ).

The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor.

Furthermore, the base station in the present disclosure may be interpreted as a mobile station (hereinafter, a user terminal). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, mobile stations may have the functions of the base stations described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the mobile station in the present disclosure may be interpreted as base station. In this case, the base station may have the functions of the mobile station described above. A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “T” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one of more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

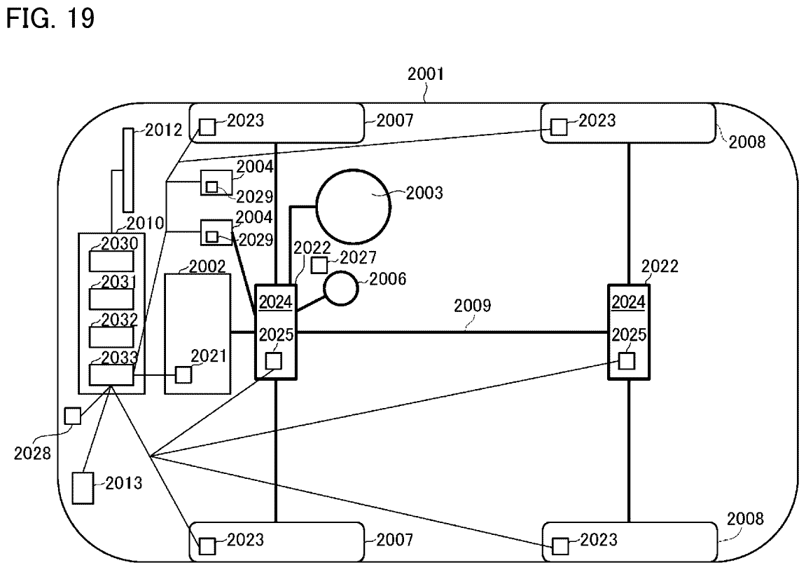

FIG. 19 shows a configuration example of a vehicle 2001. As shown in FIG. 19, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2027 provided in the vehicle. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal coming from a current sensor and input to the electronic control unit 2010 to an external device via radio communication. Further, the communication module 2013 transmits a rotation speed signal of a front wheel and a rear wheel acquired by the revolution sensor 2022, a pressure signal of a front wheel and a rear wheel acquired by a pneumatic sensor 2023, a speed signal of a vehicle acquired by a vehicle speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic control unit 2010 to an external device via radio communication.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### Reference Signs List

10 Radio communication system
20 NG-RAN
40 OAM/RIC
100 gNB
110 Radio communication unit
120 Handover processing unit
130 Measurement configuration unit
140 Control unit
200 UE
210 Radio communication unit
220 Measurement reporting unit
230 Handover executing unit
240 Control unit
1001 Processor
1002 Memory
1003 Storage
1004 Communication device
1005 Input device
1006 Output device
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A radio base station comprising:
a communication unit that performs communication with a terminal through one or more radio communication devices connected to same base station device; and
a control unit that, when the terminal transits from a first cell to a second cell that are formed by the radio communication device, establishes a state where both the first cell and the second cell are connected to the terminal by using a layer 1 function.

2. The radio base station according to claim 1, wherein
the control unit causes unacknowledged data in a first radio link control layer on a side of the first cell to be transmitted to a packet data convergence protocol layer on a side of the base station device, and
the packet data convergence protocol layer causes the data to be transmitted to a second radio link control layer on a side of the second cell.

3. The radio base station according to claim 2, wherein
the first radio link control layer resets the first radio link control layer and then retransmits the data to the second radio link control layer; or retransmits the data to the second radio link control layer without resetting the first radio link control layer and after retransmitting the data, resets the first radio link control layer.

4. A terminal comprising:
a control unit that controls a measurement of a cell including a serving cell; and
a transmission unit that transmits a report of the measurement, wherein
the control unit controls a measurement of the serving cell and a neighbor cell at layer 1.

5. The terminal according to claim 4, wherein
when a failure at the layer 1 occurs, the control unit notifies a radio resource control layer of information on the failure.

6. A radio communication system comprising:
a terminal; and a radio base station, wherein
the terminal includes:
a control unit that performs a measurement of a serving cell; and
a transmission unit that transmits a report of the measurement,
the radio base station includes a reception unit that receives the report,
the control unit performs a measurement of the serving cell and a neighbor cell at layer 1, and
the reception unit receives the report including a measurement results of the serving cell and the neighbor cell.
